(19) United States
(12) Patent Application Publication
(10) Pub. No.: US 2007/0039234 A1
(43) Pub. Date: Feb. 22, 2007

(54) Method and apparatus for trapping insects

(76) Inventor: Gerd Reime, Bühl (DE)

Correspondence Address: RABIN & Berdo, PC, 1101 14TH STREET, NW, SUITE 500, WASHINGTON, DC, 20005, US

(21) Appl. No.: 10/571,679

(22) PCT Filed: Sep. 15, 2004
(86) PCT No.: PCT/EP04/10342

§ 371 Date: Mar. 13, 2006

(30) Foreign Application Priority Data
Sep. 17, 2003 (DE) 103 42 939.5

(51) Int. Cl. A01M 1/04; A01M 3/00

(52) U.S. Cl. 43/113; 43/134

(57) ABSTRACT

A device for capturing insects comprises a housing (10) with a capturing opening (11) and comprises an immobilizing device for at least temporarily immobilizing the insects. Captured insects are kept in a collecting device (13) for collecting and retaining after they have passed through the capturing opening (11). Insects can be captured in a simple and convenient manner by virtue of the fact that a capturing area, which can be influenced at least temporarily by the immobilizing device, is provided outside of the device having the associated capturing space (14) in order to bring the insects from this capturing space to the collecting device (13) via the capturing opening, and that the immobilizing device is formed by at least one light source (12) for blinding the insects. After switching on the immobilizing device, the capturing space must be merely placed over the insect so that the insect then enters the collecting device (13).

### REFERENCE TO RELATED APPLICATIONS

The present application claims the priority of German Patent Application 103 42 939.5, filed on 17 Sep. 2003, the disclosure content of which is also hereby expressly made the object of the present application.

### FIELD OF THE INVENTION

The invention relates to an apparatus and a method for trapping insects in accordance with the preamble of claims 1 or 19, with which apparatus particularly irksome insects, such as common houseflies, mosquitoes and more especially midges, can be trapped.

### START OF THE ART

Numerous methods and apparatuses to catch insects, more especially flying insects, have already been proposed. Paper strips that can be hung from the ceiling and are provided with an adhesive are known in the domestic sector. If an insect comes too close to the adhesive, it remains stuck to it. On the other hand, devices are known where insects can be lured more especially by means of UV light, subsequently being killed on a grid that is supplied with electric current.

DE 43 27 150 A1, on which the main preamble of claim 1 is based, makes known an apparatus in the form of a hand-held device, where an insect is pulled into a collecting area by means of a partial vacuum, which is generated where necessary. The insects are immobilized or respectively killed by the partial vacuum and can then be disposed of from the collecting area.

WO-A 93/25073 makes known a laser device for keeping insects away. The laser is used to dazzle the insects until they have been destroyed in front of an opening to be protected, but does not trap the insects.

DE 695 12 266 T2 uses a light source to attract insects, in this case a surface is illuminated and said surface interacts with a surface that is supplied with electric current and on which the insect is killed on contact. The immobilizing of the insects is effected on contact with the surface that is supplied with electric current. Similar trap apparatuses are known in DE 35 11 215 C2 and DE 198 35 059 A1.

DE 690 29 727 T2 makes known a comparable apparatus, where a UV light source is used to attract the insects, however, the grid connected behind is provided with a non-deadly electric charge. The insects can be stunned by this and moved into a collecting container. The immobilizing by the electrically charged grid is effected behind the trap opening.

### SUMMARY OF THE INVENTION

Proceeding from the state of the art, it is the object of the present invention to create an apparatus and a method for trapping insects in a handy, simple manner.

This object is achieved by an apparatus and a method with the features of claim 1 or respectively 19.

The immobilizing device is effective in the area in front of the trap opening on a trap area or trap region in such a manner that the insect, which is preferably already no longer flying, before contacting the apparatus is already immobilized in such a manner that it can be trapped. The insect then passes into a collecting container once the immobilizing device has been switched off. The insects are gently collected up and can be removed from the collecting container later where required. This is an important advantage, more especially for members of world religions who believe that the soul is reborn again in a different body.

The immobilizing of the insects is preferably effected by means of dazzling, a pulsing light at a frequency of between 5 and 20 Hertz being the most effective. The fact that pulsing light has this effect on insects seems not to be known in biology. This light is already effective in a trap region at some distance in front of the apparatus, such that the insects detected by the light no longer fly away. Due to the dazzle effect, the insects remain still such that they can be transferred into a trap area by the trap area being slipped over the said insects. The insects can then be moved into the collecting container and once the light source has been switched off and the dazzle effect has weakened, this usually occurs by the insects independently following their escape instinct and escaping into the collecting container.

The escape instinct can be supported by obscuring the trap area once the insect has been detected. This can be effected by means of a relative movement between trap area and housing, such that the dark housing is guided over the transparent trap area, at the same time, however, the light can be switched off in the trap area. Under certain circumstances, it would be enough to have light entering from the outside in the transfer region to the collecting container. It is preferable to have another light source disposed here also. If the volume of the trap area is also reduced at the same time, the insect, following its escape instinct, looks for the path to the light and consequently passes into the collecting container. A mechanical apparatus, as an auxiliary means, can be installed in the trap area to move the insect forward into the trap opening.

Further advantages are produced from the sub claims.

### SHORT DESCRIPTION OF THE FIGURES

The invention is described in more detail below by way of the enclosed Figures. In which:

FIG. 1 is a side view of the apparatus, in the form of a hand-held device, in the initial state,

FIG. 2 is a front view of the apparatus in FIG. 1,

FIG. 3 is a sectional view of the apparatus in a representation according to FIG. 1,

FIG. 4 is a section through the trap sleeve,

FIG. 5 is a representation according to FIG. 3 with the obscured trap area applied to a contact surface,

FIG. 6 is a front view of the trap area in an additional specific embodiment.

### DETAILED DESCRIPTION OF PREFERRED EMBODIMENTS

The invention is now described in more detail as an example with reference to the enclosed drawings. However, the exemplified embodiments are only examples which are not to restrict the inventive concept to a specific disposition.

The apparatus represented in the Figures is for trapping insects, more especially flying insects, such as common houseflies, mosquitoes and midges, but also wasps, bees and the like. A hand-held device is represented in the exemplified embodiment, however, in principle, the apparatus can also be used in other ways. In the configuration as a hand-held device, the apparatus can be developed, in principle, in such a manner that it fits in every pocket. Depending on requirement, it can be used particularly in hospitals, clean rooms, in private areas or also in the catering trade where it is used to remove insects that are no longer flying away from the vicinity of customers' foodstuffs and meals.

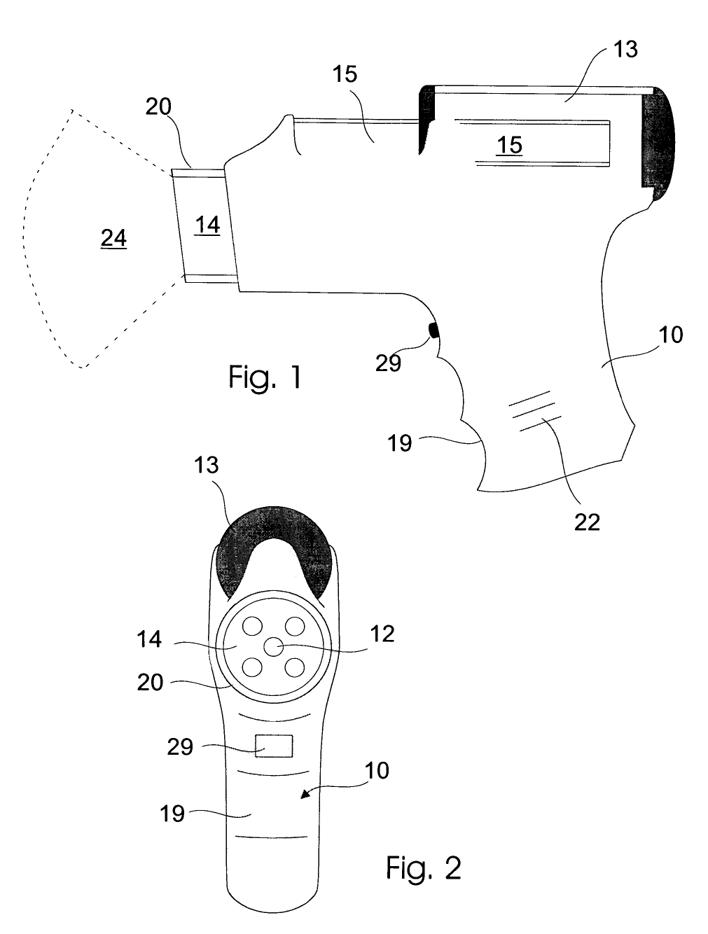

The apparatus has a housing 10 with a trap opening 11, which is disposed in the present case in the wall 14a of a trap sleeve 20 which surrounds the trap area 14. In addition, an immobilizing device is provided for the at least partial immobilization of the insects. The immobilizing device in the exemplified embodiment is formed by a light source 12, which has the job of dazzling the insects which have been caught in the trap region 24, which is illustrated schematically in FIG. 1 in front of the device, or in the trap area 14. The at least one light source 12 can be an electric light bulb or, equally as good, an LED, wherein more especially a, for example, sinusoidal or square-wave pulsing of the light source has been proven to be advantageous. Once the trap area has been slipped over the insect, the intensity of the light source is preferably dimmed from 0 to 100%, a period lasting approximately two seconds being proven to be suitable for this purpose. The preferably temporary dazzle effect also occurs at constant light, but is worse. Other means can also be used as the immobilizing device as long as it is ensured that they are harmless to people and to higher-evolved animals, on the other hand, however, it must also be ensured that they preferably only accomplish a partial immobilizing or respectively dazzling of the insects.

The light source 12 preferably shines out of the apparatus with a narrow beam. Consequently, an insect can be sighted, for example, at 1 m away. Although the user then approaches the insect, the insect stops until the trap area 14 has been slipped over it. As the trap area is preferably transparent at least in the front region, the insect does not perceive it initially with its compound eye on account of the dazzle. The trap area 14 must not be a tube; it can equally be defined, for example, by a grid or net. Once the trap area has been slipped over the insect, the said trap area can be obscured in order to move the insect, or respectively to have the insect moved, in the direction of a collecting device 13 for collection and retention of the insects once they have passed the trap opening 11.

In front of the trap opening 11 there is provided the trap area 14, which can be influenced at least partially by the immobilizing device. In the exemplified embodiment, the light source is effective in both the trap region 24 (FIG. 1) in front of or respectively outside the apparatus and in the trap area 14 and dazzles the insects situated in this region. The insects pass from the trap area via the trap opening 11 into a transfer region 15 to the collecting device 13. The transfer region can be formed simply by an opening, for example the trap opening 11, however it is preferable for the transfer region to be a separate element or respectively a separate area.

The light source 12, which is disposed in the vicinity of the trap opening 11, is operated at a wavelength that is at least visible to the insect eye. A modulation of between 5 and 20 Hertz, preferably 10 Hertz, has proven to be advantageous. At this modulation, the insect begins to sway and to shake and this makes it easier for the trap area to be slipped over. It is preferable for only one light source to be used, however several can be provided.

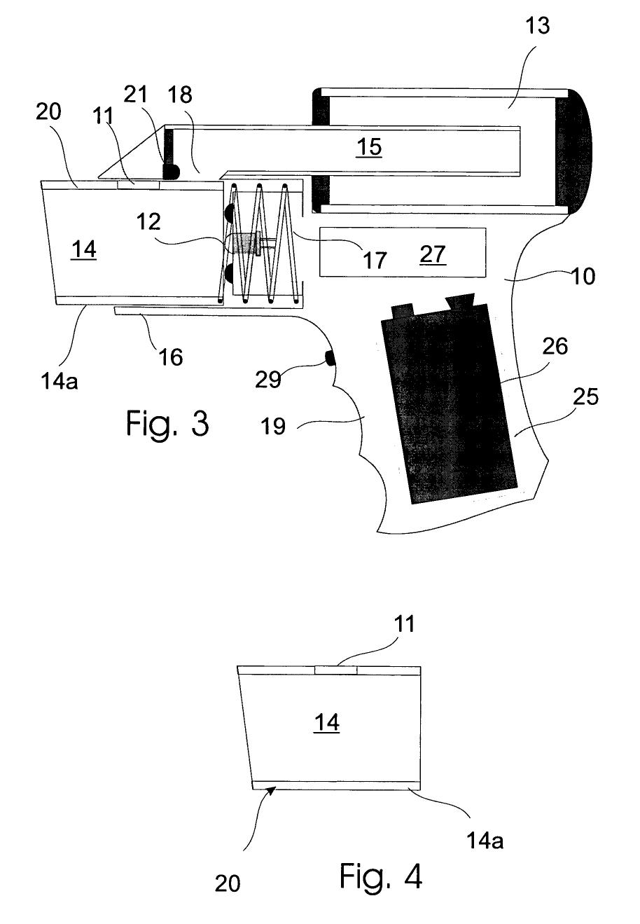

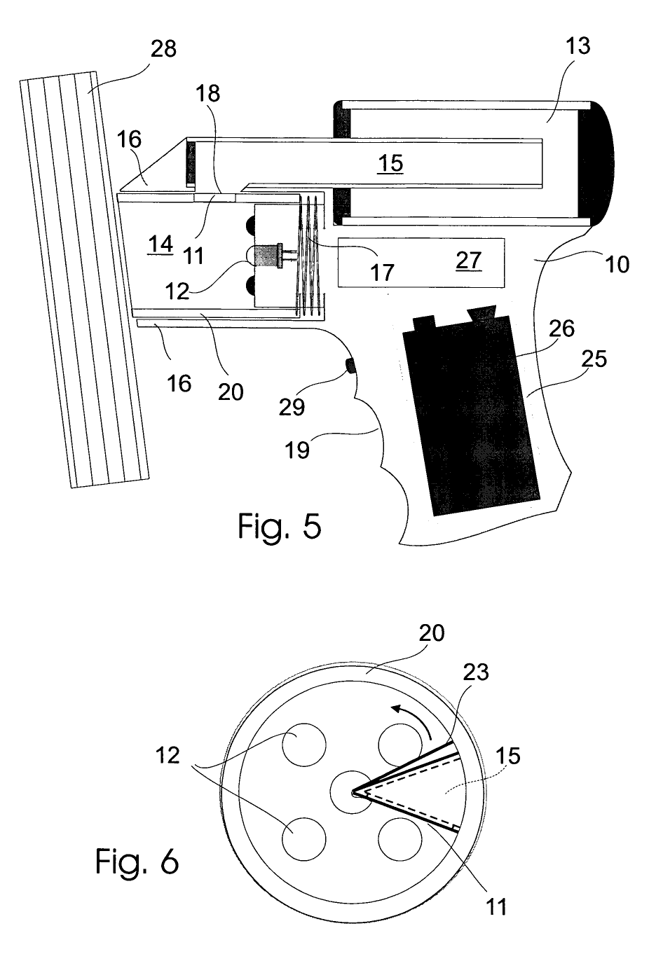

In order to cause the insects to leave the trap area 14 once the immobilizing or respectively dazzling effect has been reduced, the said trap area is obscured. The obscuring occurs in the exemplified embodiment, as a comparison between FIGS. 3 and 5 shows, by the housing 10 being moved relative to the trap area 14 or respectively to the trap sleeve 20 once the trap area 14 has been slipped over the insect. This results in the preferably opaque housing 10 passing over the transparent trap sleeve 20 as obscuring element 16.

The relative movement between housing 10 and trap sleeve 20, however, has other consequences also. The transfer region 15 is only opened by this relative movement, for example. The transfer region consequently forms, as can be seen at the earliest in FIG. 5, a lock that is closable at least on one side. This means that insects situated in the collecting device 13 cannot easily pass back into the trap area 14. To generate the relative movement, the trap sleeve 20 is mounted on the housing 10 so as to be displaceable in a limited manner preferably in opposition to the force of at least of one resilient element 17.

The light source 12 can either be moved together with the trap area 14 or, as shown in the Figures, can be secured to the housing 10 such that the insect passes closer to the light source when the trap area moves relative to the housing 10. The movement that occurs in this case can be used at the same time, through corresponding geometry of the housing 10, to reduce the volume of the trap area 14 in such a manner that the insect becomes distressed.

According to FIG. 5, the relative movement results in the trap opening 11 and the connection opening 18 coinciding, which means that, for the insect, the path, which is otherwise blocked up preferably as a lock, opens into the collecting device 13. This transfer region 15, more especially when the trap area 14 is obscured, is preferably disposed such that the insect passes via the transfer region 15 into the collecting device 13. At the same time, light can pass to the insect via the transfer region 15 such that the insect is lured in this direction. This light can either be the ambient light or also a separate light source. In the exemplified embodiment, the wall of the collecting device 13 is transparent and/or diffused such that a diffused light can pass as far as the connecting opening 18. If the connecting opening, as transfer region to the collecting device 13, is opened by means of the movement of the trap area relative to the housing 10, the insect, as illustrated, for example, in FIGS. 3 and 5, passes into a separate container, which is also associated with the transfer region 15 and ends in the collecting device 13. The insect consequently follows the light and comes into the collecting device 13 via the separate container of the transfer region 15. The area widens again in the collecting device 13, which means that the insect cannot pass voluntarily back into the transfer region 15. Even if it does so, it is kept back by the lock which is disposed at the entry of the transfer region 15 and is formed by the trap opening 11 and the connecting opening 18. The cross section of the preferably tubular transfer region 15 is adapted to the insects to be caught such that they still pass along this cross section as the escape route, however, after leaving the cross section they do not want to return there. This reluctance is the one side of the lock, the other side of the transfer region should preferably be in the form of an actual opening, which, like a lock, only allows insects to enter but not to leave. Where necessary, it is also possible to provide a double lock.

In practice, there have been insects that have been reluctant to leave the trap area 14 in the direction of the collecting device 13, such that the insect could only be caught after a few seconds. Consequently, in order to make use of the device more pleasant for the user, in the exemplified embodiment in FIG. 6 which shows a view of the trap area 14 from the front, a mechanical apparatus can be provided for lifting off the insect. This apparatus moves the insect situated in the trap area forward into the trap opening 11, which then preferably remains closed until the insect has found the path into the collecting container 13. If, therefore, in FIG. 6 the trap area 14 is slipped over the insect, after it has been dazzled by the light of the light source 12, the relative movement between trap sleeve 20 and housing 10 results in a wedge-shaped region, for example, coming from the boundary face of the trap area 14 on the user side preferably to the contact surface 28, which includes the trap opening 11 to the side. In this respect, this wedge-shaped region is part of the connecting region 15. On the side of the wedge situated opposite to the trap opening 11 there is, as the mechanical apparatus, for example, a wiper 23, which is represented in the initial or idle state in FIG. 6 and, after being placed on the contact surface 28, wipes in a circular manner through the trap area and at the same time moves the insect forward into the collecting container 11. It stops at the trap opening until the insect has reached the collecting container. A signal of the detecting device 21 or, for example, the actuating of the control device 29 by the user can be used as a signal for this, the wiper 23 then returning to its initial position or, if the wedge-shaped region returns to its initial position and this is desired, wipes over this region, which results in a 360° movement of the wiper. The trap opening 11 is preferably opened when the wedge-shaped region is released and automatically closed when the apparatus is lifted off, such that this forms one side of a lock, which prevents the insect moving back into the trap area 14. An additional side of a lock can be provided on the other side, such that the connecting region 15 is no longer accessible from the collecting container when the trap opening is open, but once the trap opening 11 has been closed, it is possible for the caught insect to escape into the collecting container.

As an alternative, in a specific embodiment not represented in a drawing, once the insect has been caught in the trap area 14 and the housing has been placed on the contact surface 28, the trap sleeve 20 can also be lifted off internally of the obscuring element or of the housing 10, such that a wiper can “clean out” the trap area 14 under the trap sleeve in order thereby to move the insect forward into the trap opening. Both solutions, moreover, have the advantage that it is consequently easier also to remove an insect from a window pane on which the obscuring effect does not occur to the same extent as it does on another surface. However, in the case of this type of mechanical or electrically driven apparatus for lifting off the insects, an obscuring means is no longer urgently necessary.

The advantage of the entire apparatus, which is in the form of a hand-held device in the exemplified embodiments, is above all that the insects are only immobilized for the short term, then, however, preferably pass into the collecting device 13 by themselves through their own effort. The insects are consequently not killed which means that it remains up to the user what he does with the insects after “collection”. For this purpose, the substantially closed collecting device 13 is removable from the housing 10 for the transport, release or disposal of the caught insects. Animal conservationists or believers of world religions that believe in rebirth, can, for example, subsequently release the insects.

According to the Figures, the apparatus includes a handle element 19, which makes it easy to grasp. A control element 29 for actuating the light source is provided on the handle element 19 itself. The light source is supplied with power, for example, from a battery 26 in the battery compartment 25. The control elements are disposed, for example, on a printed circuit board 27. The trap area 14, which is disposed in the trap sleeve 16, preferably extends forward beyond the housing 10 as shown in FIG. 1, such that when the trap area is slipped over the insect, the demarcation of the trap area 14 can be detected.

As the trap area 14 is no longer visible after it has been obscured by being introduced into the housing 10 on account of the relative movement, a detecting apparatus 21 can be provided in the transfer region 15 for detecting the passage of caught insects, as shown in FIG. 3. This detecting apparatus can either show that an insect has passed the transfer region or there is at least one signal transmitter 22 provided which gives an acoustic or optical signal when an insect passes through on account of the signal from the detecting apparatus. In addition, the transfer region 15 can also be transparent, which means that the user can observe whether the insect has passed into the collecting device.

It has been shown that the dazzle effect is also dependent on the ambient light. If the insect is dazzled too strongly at night, for example, it can be several seconds before the dazzle effect is weakened and the insect begins to escape. In order to optimize this, a light sensor can be provided additionally to detect the ambient light, such that the light source is tuned in a corresponding manner to the ambient brightness.

Preferred wavelengths of the light are in the green, blue and white range, whilst red and infrared have proven to be less advantageous; the choice, however, is also dependent on the insects to be caught in each case. The trap area itself, in the exemplified embodiment, has a diameter of between 20 and 40 mm and the housing in the region of the trap area 14 has a diameter of between 25 and 45 mm. For better sealing, for example, on an uneven support base, a rubber pad or a rubber contact ring can be provided, where required, in this region at the bottom edge of the trap area.

The apparatus itself operates as follows: The immobilizing device is initially effective in front of the apparatus and more especially in front of the trap opening 11 out of the apparatus into the trap region 24. Consequently, the immobilizing device can influence trap region 24 and trap area 14. An insect situated in this region is consequently already immobilized from a certain distance, such that the trap area 14, which can be influenced by the immobilizing device and is disposed in front of the trap opening, can then be slipped over the insect that is situated on the contact surface 28. The insect caught in this manner then passes, due to its escape instinct or with the assistance of the mechanical apparatus for lifting off the insect—such as, for example, the wiper 23—via a transfer region 15 into the collecting container 13. The wiper can, for example, be transferred into its initial position by means of a spring or an electrical drive means. In the exemplified embodiment, the immobilizing device is a light source, which is not there for attracting the insects but for dazzling them. Once the dazzle effect has been reduced, the insect preferably passes independently into the trap opening 11.

The light source is operated at a wavelength that is at least visible to the insect eye. Once the trap area 14 has been slipped over the insect, the transfer region 15 is obscured. A relative movement between the at least partially transparent trap sleeve 20 and the housing 10 can be effected for this purpose, for example, such that the housing 10 darkens the trap area. Thus, the transfer region 15 is opened, as trap opening 11 and connecting opening 18 to the collecting device 13 come in coincidence. At the same time, the volume of the trap area 14 is reduced by means of the relative movement between trap sleeve 20 and housing 10. This movement can also be used to switch off the light source 12. All this influences the insect's instinct to escape. The instinct to escape is increased by light passing via the transfer region 15 towards the insect, such that the insect is lured in this direction. When the insect passes through the transfer region 15, a detecting apparatus 21 can detect whether the insect has actually passed in the direction of the collecting device 13, so that an acoustic or optical signal is output. The apparatus can then be removed again from the support on which the insect has been caught, and can be used again.

It is obvious that this description can be subject to the most varied modifications, amendments and adaptations, which range in the region of equivalents to the attached claims.

### LIST OF REFERENCES

10 Housing
11 Trap opening
12 Light source
13 Collecting device
14 Trap area
14a Wall
15 Transfer region
16 Obscuring element
17 Resilient element
18 Connecting opening
19 Handle element
20 Trap sleeve
21 Detecting apparatus
22 Signal transmitter
23 Wiper
24 Trap region
25 Battery compartment
26 Battery
27 Printed circuit board
28 Contact surface
29 Control element

1. Apparatus for trapping insects, said apparatus including
a housing with a trap opening,
a light source for dazzling and for at least partial immobilizing of the insects,
a collecting device for collecting and retaining insects which have passed the trap opening,
a trap region provided in front of the trap opening and which trap region can be at least partially influenced by the light source and is provided externally of the apparatus with associated trap area in order to bring the insects from said trap region via the trap opening to the collecting device,
wherein the apparatus comprises an obscuring element covering the obscureable a trap area and wherein a mechanical apparatus is provided to lift the insects off a contact surface.

2. Apparatus according to claim 1, wherein the light source, disposed in the vicinity of the trap opening, is operated at a wavelength that is visible at least to an insect eye.

3. Apparatus according to claims 1, wherein the light source His a light source modulated between 5 and 20 Hertz, preferably 10 Hertz.

4. Apparatus according to claim 1, wherein a lock, which is at least closable on one side, is provided in a transfer region between trap opening and collection device.

5. Apparatus according to claim 1, wherein when the trap area is obscured, a transfer region between trap opening and collection container is disposed such that the insect, lured by the light, passes via the transfer region into the collecting device (13).

6. Apparatus according to claim 1, wherein the obscuring element is formed by the housing.

7. Apparatus according to claim 1, wherein the trap area is mounted on the housing so as to be displaceable in a limited manner in opposition to a force of at least of one resilient element.

8. Apparatus according to claim 1, wherein the trap area comprises a connecting opening as transfer region to the collecting device, said connecting opening being opened by means of the movement of the trap area relative to the housing.

9. Apparatus according to claim 1, wherein a separate container is provided in the a transfer region to the collecting device, said separate container communicating with a connecting opening to the trap area and ending in the collecting device.

10. Apparatus according to claim 1, wherein a cross section of a transfer region to the collecting device is adapted in such a manner to the insects to be caught that the insects still follow the cross-section as their escape route.

11. Apparatus according to claim 1, wherein the collecting device can be opened or is removable from the housing for at least one of transport, release or disposal of the trapped insects.

12. Apparatus according to claim 1, wherein the apparatus is a hand-held device.

13. Apparatus according to claim 1, wherein a control element for the actuation of the light source is provided on a handle element of the apparatus.

14. Apparatus according to claim 1, wherein a detecting apparatus for detecting the passage of trapped insects is provided in a transfer region to the collecting device.

15. Apparatus according to claim 14, wherein at least one signal transmitter, which outputs an acoustic or optical signal when an insect passes through the transfer region (15), is associated with the detecting apparatus (21).

16. Apparatus according to claim 1, wherein a mechanical apparatus is provided to move the insects into the trap opening.

17. Apparatus according to claim 16, wherein the mechanical apparatus is formed by a wiper disposed in the trap area or in the obscuring element in front of the trap area.

18. Method for catching insects through the intermediary of an apparatus, which includes:
a housing with a trap opening,
at least one light source for dazzling and for the at least partial immobilizing of at least one insect,
a collecting device for collecting and retaining insects which have passed the trap opening,
comprising the steps:
using the at least one light source in a trapping region, that can be at least partially influenced, externally of the apparatus with an associated trap area, dazzling the insect through the intermediary of the at least one light source,
slipping the trap area, which is disposed in front of the trap opening and can be influenced by the at least one light source and is at least partially transparent, over the insect,
guiding or conveying the insect out of the trap area via the trap opening to the collecting device
obscuring the trap area through a relative movement of the trap area relative to an obscuring element,
mechanically lifting the insect off a contact surface.

19. Method according to claim 18, wherein the light source is operated at a wavelength that is as least visible to an insect eye.

20. Method according to claim 18, wherein the light source is modulated with a frequency between 5 and 20 Hertz, preferably 10 Hertz.

21. Method according to claims 18, wherein once the trap area has been slipped over the insect, the intensity of the light source is dimmed from 0 to 100%.

22. Method according to claim 21, wherein the dimming lasts for approximately two seconds.

23. Method according to one of claims 18, wherein the trap area is obscured as far as a transfer region to the collecting device shortly before or after being slipped over the insect.

24. Method according to claims 18, wherein in obscuring the trap area by means of a relative movement of the trap area relative to the housing forming the obscuring element, at the same time a transfer region (15) to the collecting device is opened.

25. Method according to claims 18, wherein the trap opening is opened by means of a relative movement of the trap area relative to the housing and the insect to be caught passes into the trap opening mechanically through the intermediary of auxiliary means or through its own initiative.

26. Method according to claims 18, wherein the trap opening is automatically closed when the apparatus is lifted off the contact surface and the insect passes into the collecting device via a lock region.

27. Method according to claims 18, wherein the volume of the trap area is altered by moving the trap area relative to the housing.

28. Method according to claims 18, wherein after the trap area has been slipped over the insect, the light source is switched off preferably by means of a relative movement of the trap area relative to the housing.

29. Method according to the claim 28, wherein after the light source has been switched off or simultaneously as the light is being switched off, an additional light source is switched on to illuminate the escape route.

30. Method according to claims 18, wherein a detecting apparatus, which is disposed in the a transfer region to the collecting device, gives a signal to a signal transmitter for an acoustic or optical signal in dependence on the detecting of the insects passing the transfer region.

31. Method according to claims 18, wherein the insect is moved into the trap opening (11) in a mechanical manner.

32. Method according to claim 31, wherein the trap opening is closed until the insect has found the way into the collecting device

33. Method according to claim 31, wherein the trap area is cleaned out by means of a mechanical apparatus as soon as the trap sleeve is slipped over the insect.
